(19) United States
(12) Patent Application Publication
(10) Pub. No.: US 2015/0187030 A1
(43) Pub. Date: Jul. 2, 2015

(54) METHOD AND SYSTEM FOR FACILITATING COMMUNICATION REGARDING REAL PROPERTY TRANSFERS

(71) Applicant: Steffen Meschkat, Zurich (CH)

(72) Inventor: Steffen Meschkat, Zurich (CH)

(73) Assignee: GOOGLE INC., Mountain View, CA (US)

(21) Appl. No.: 13/191,431

(22) Filed: Jul. 26, 2011

(51) Int. Cl. G06Q 50/16; G06F 17/30; H04L 29/08; G06F 15/16; G06F 3/0484

(52) U.S. Cl. CPC G06Q 50/167; G06F 3/04842; H04L 67/10; G06F 17/30241

(57) ABSTRACT

A computerized system includes a real property database having a plurality of entries, each entry representing a geographic location and comprising at least a geographic location field containing information regarding the geographic location, and a communication and editing system in communication with the database and a remote computer. The communication and editing system is programmed to display information relating to an entry at the first remote computer, receive from the first remote computer a selection of the entry, confirm that the selection from the first remote computer originated with a right holder associated with the geographic location, display information relating to the entry at the second remote computer, receive from the second remote computer a selection of the entry, receive communication channel and/or transfer price information from the second remote computer, and provide the communication channel and/or transfer price information to the right holder.

### FIELD OF TECHNOLOGY

This patent is directed to system and method for facilitating real property transfers, and in particular a system and method for facilitating communication regarding real property transfers.

### BACKGROUND

When real property is offered for sale, the owner or an agent of the owner (which may be a real estate broker) will prepare a description of the real property that is circulated to other parties with the intent of attracting the attention of a prospective buyer or an agent of the buyer.

In many locations, real estate brokers have formed trade organizations that allow the member brokers to enter the description generated regarding a particular real property into a centralized database. The database will generally adhere to a predetermined set of criteria and rules in regard to the description. The database associated with a Multiple Listing Service (MLS) is one example of such a centralized database used by real estate brokers in the U.S.

One limitation of such MLS databases is that they are generally closed to outsiders. In particular, a particular MLS database is only generally available to real estate brokers who qualify for access to that particular MLS database and are members of the relevant trade association(s). While a specific MLS may permit non-brokers to view parts of the MLS database, non-brokers or non-members generally do not have unrestricted access to the database. Moreover, non-broker owners are generally unable to post a listing to the database.

Another limitation is that the owner or the broker working with the owner (typically referred to as the seller's agent) typically must generate the description of the real property at the time the owner decides to sell the real property, as mentioned above. Consequently, while the owner or agent may work from examples of similar descriptions prepared for other properties, the process of preparing the description is performed at the time the owner decides to offer the real property for sale.

### SUMMARY

According to an aspect of the present disclosure, a computer implemented method is provided for use with a computerized database comprising a plurality of entries, each entry comprising at least a geographic location field containing information regarding a geographic location. The method includes displaying information relating to an entry at a first remote computer, receiving from the first remote computer a selection of the entry, and confirming that the selection from the first remote computer originated with a right holder associated with the geographic location. The method also includes displaying information relating to the entry at a second remote computer, receiving from the second remote computer a selection of the entry, and receiving communication channel information from the second remote computer to permit a communication channel to be established with an interested party at the second remote computer. Further, the method includes providing the communication channel information to the right holder.

According to another aspect of the present disclosure, a computerized system includes a real property database comprising a plurality of entries, each entry representing a geographic location and comprising at least a geographic location field containing information regarding the geographic location, and a communication and editing system in communication with the database and at least first and second remote computers. The communication and editing system is programmed to display information relating to an entry at the first remote computer, receive from the first remote computer a selection of the entry, confirm that the selection from the first remote computer originated with a right holder associated with the geographic location, display information relating to the entry at the second remote computer, receive from the second remote computer a selection of the entry, receive communication channel information from the second remote computer to permit a communication channel to be established with an interested party, and provide the communication channel information to the right holder.

According to a further aspect of the present disclosure, a computer implemented method is provided for use with a computerized database comprising a plurality of entries, each entry comprising at least a geographic location field containing information regarding a geographic location. The method includes displaying information relating to an entry at a first remote computer, receiving from the first remote computer a selection of the entry, and confirming that the selection from the first remote computer originated with a right holder associated with the geographic location. The method also includes displaying information relating to the entry at a second remote computer, receiving from the second remote computer a selection of the entry, receiving transfer price information from an interested party at the second remote computer. Further, the method includes providing the transfer price information from the interested party to the right holder.

According to a still further aspect of the present disclosure, a computerized system includes a real property database comprising a plurality of entries, each entry representing a geographic location and comprising at least a geographic location field containing information regarding the geographic location, and a communication and editing system in communication with the database and at least first and second remote computers. The communication and editing system is programmed to display information relating to an entry at a first remote computer, receive from the first remote computer a selection of the entry, confirm that the selection from the first remote computer originated with a right holder associated with the geographic location, display information relating to the entry at a second remote computer, receive from the second remote computer a selection of the entry, receive transfer price information from an interested party at the second remote computer, and provide the transfer price information from the interested party to the right holder.

### BRIEF DESCRIPTION OF THE DRAWINGS

It is believed that the disclosure will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings is necessarily to scale.

FIG. 1 is a schematic of an exemplary computerized system that may be used with a computer implemented method for facilitating real property transfers according to the present disclosure;

FIG. 2 is a table representing an exemplary computerized database with which the method for facilitating real property transfers may be used;

FIG. 3 is a table representing further exemplary fields of the computerized database according to FIG. 2;

FIG. 4 is a table representing still further exemplary fields of the computerized database according to FIG. 2;

FIG. 5 is a flowchart of an exemplary computer implemented method for facilitating real property transfers according to an embodiment the present disclosure;

FIG. 6 is a flowchart of an exemplary computer implemented method for facilitating real property transfers according to an alternative embodiment the present disclosure;

FIG. 7 is a flowchart of an exemplary computer implemented method for facilitating real property transfers according to a further embodiment the present disclosure;

FIG. 8 is a simulated screenshot of an image generated from information of an unclaimed entry in the computerized database;

FIG. 9 is a simulated screenshot of a real property listing image associated with the unclaimed entry illustrated in FIG. 8;

FIG. 10 is a simulated screenshot of an image generated from information edited by a right holder after selecting the unclaimed entry in the computerized database;

FIG. 11 is a simulated screenshot of a real property listing image associated with the unclaimed entry illustrated in FIG. 10;

FIG. 12 is a flowchart of an exemplary computer implemented method for facilitating real property transfers according to a further alternative embodiment the present disclosure;

FIG. 13 is a flowchart of an exemplary computer implemented method for generating real property listings according to the present disclosure;

FIG. 14 is a simulated screenshot of an image generated to convey information to a party relating to an unclaimed entry in the computerized database according to FIG. 2;

FIG. 15 is a simulated screenshot of an image generated from information edited by a right holder after selecting the unclaimed entry in the computerized database; and

FIG. 16 is a simulated screenshot of a real property listing image associated with an entry for a real property in the computerized database according to FIG. 2.

### DETAILED DESCRIPTION

In general terms, the present disclosure relates to a computer implemented method, as well as the associated computerized system for carrying out the method. The method is for use with and the system includes a computerized database (which may be referred to as a real property database) having a plurality of entries, each entry representing a geographic location and comprising at least a geographic location field containing information regarding the geographic location. The database may be in communication with a communication and editing system that is programmed to carry out the method. For example, the method may include displaying information relating to an entry at the first remote computer, receiving from the first remote computer a selection of the entry, and confirming that the selection from the first remote computer originated with a right holder associated with the geographic location. The method may also include displaying information relating to the entry at the second remote computer, receiving from the second remote computer a selection of the entry, receiving communication channel (e.g., e-mail or SMS addresses, telephone numbers, or the like) and/or transfer price information from the second remote computer, and providing the communication channel and/or transfer price information to the right holder.

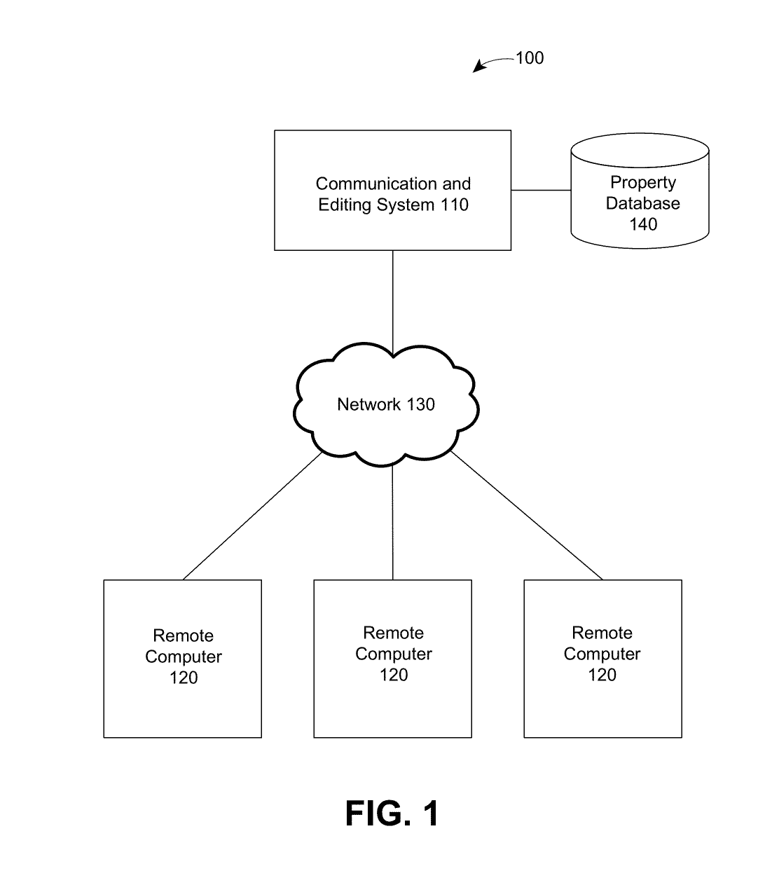

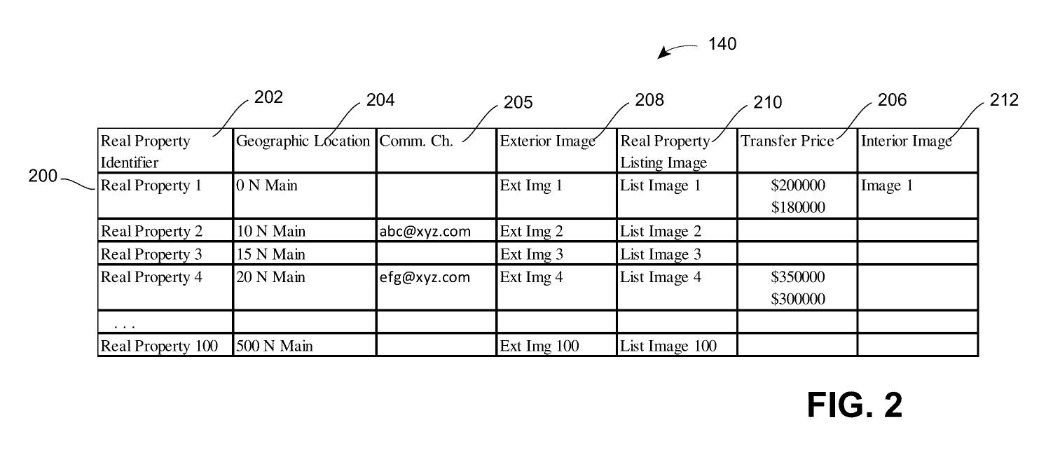

As to one embodiment of the present disclosure, FIG. 1 illustrates a computing environment 100 for a computer implemented method for facilitating real property transfers by facilitating communication between parties regarding real property transfers, which may involve the generation of listings for real property (“real property listings”). As seen in FIG. 1, the computing environment 100 includes a communication and editing system 110, in the form of one or more servers, connected to a number of remote computers 120 through one or more networks 130. A computerized real property database 140 is illustrated as associated with and in communication with the communication and editing system 110. The database 140 is further illustrated in subsequent FIGS. 2-4.

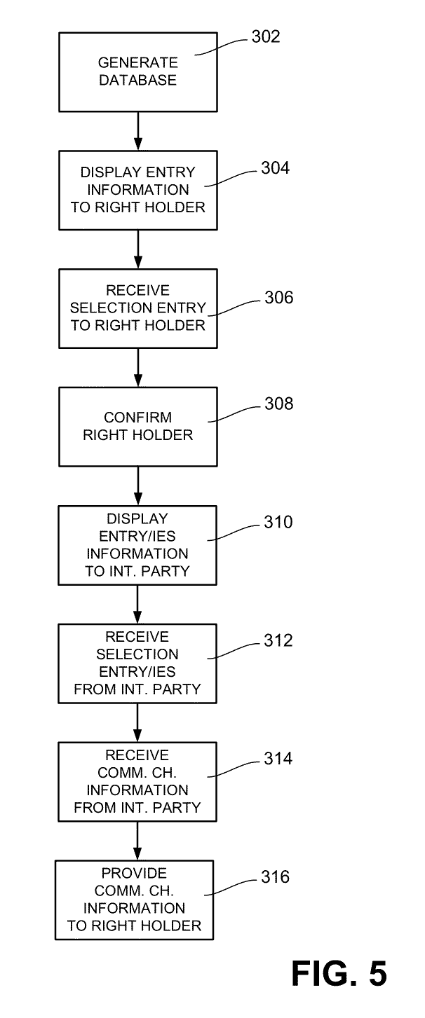

Turning to FIGS. 5-7 and 12, illustrated therein are several embodiments or variants of a computer implemented method for facilitating real property transfers, in particular for facilitating communication regarding real property transfers, for use with the computing environment or system 100. The method is to be used with a real property database (such as database 140) that has already been generated, at least in part, prior to selection of an entry of the database by a party interested in receiving an ownership right (an interested party) in the real property represented by this entry in the database, which interested party may be transferee, such as a buyer, a lessee, or an agent of one of these transferees, according to the facts of the contemplated transaction. In fact, the method does not wait for a right holder to make the decision to sell real property or to lease a building or a unit of a building associated with real property before the entry for the real property is established in the real property database 140, or even for the right holder to establish their identification as the right holder associated with the property (to the extent required by the method and system according to the present disclosure). Instead, the method (and the system 100 carrying out the method) provides the interested party with a pre-established entry representative of the real property in which an interested party may indicate their interest in receiving a transfer even before the entry is claimed and edited by the right holder to provide a tailored real property listing for the real property.

As a consequence, the method encompasses the situation where the interested party indicates their interest in receiving a transfer after the entry is claimed by the right holder, but before the right holder indicates his or her interest in receiving a transfer (“an unsolicited offer”). However, this unsolicited offer may even come, as noted above, before the right holder associated with the real property has identified him or herself with the entry. Further, the method would encompass the situation where the interested party indicates their interest in receiving a transfer after the entry is claimed by the right holder and after the right holder indicates his or her interest in receiving a transfer (“a solicited offer”).

Thus, as reflected then in FIG. 5, the method begins with the generation of the database at 302. According to certain embodiments of the present disclosure, the party who will provide the right holder the ability to edit an entry in the database 140 (also referred to herein as the service provider) generates the database 140. According to other embodiments of the present disclosure, the database 140 may be generated by a party other than the service provider, which party may be referred to herein as a database generator. The database generator may be under the control of the service provider, or alternatively the database generator may generate the database 140 without instruction from the service provider and subsequently transfer the database 140 to the service provider in conjunction with the service provider carrying out the method.

The method further includes displaying information relating to an entry at a first remote computer at block 304, receiving from the first remote computer a selection of the entry at block 306, and confirming that the selection from the first remote computer originated with a right holder associated with the geographic location at block 308. However, irrespective of whether the right holder has indicated his or her interest in offering all or part of the rights associated with the geographic location associated with the entry for transfer, the method subsequently includes displaying information relating to the entry at a second remote computer at block 310, receiving from the second remote computer a selection of the entry at block 312, and receiving communication channel information from the second remote computer to permit a communication channel to be established with an interested party at block 314. Subsequently, the method may provide the communication channel information to the right holder at block 316 at some point in time after the communication channel information has been received, with or without a prior request having been received from the right holder. Such an order of steps may encompass both the solicited and the unsolicited offer situations where there the right holder has identified his or herself with the entry, and thus the geographic location and the real property thereof, prior to the selection of the entry by the interested party.

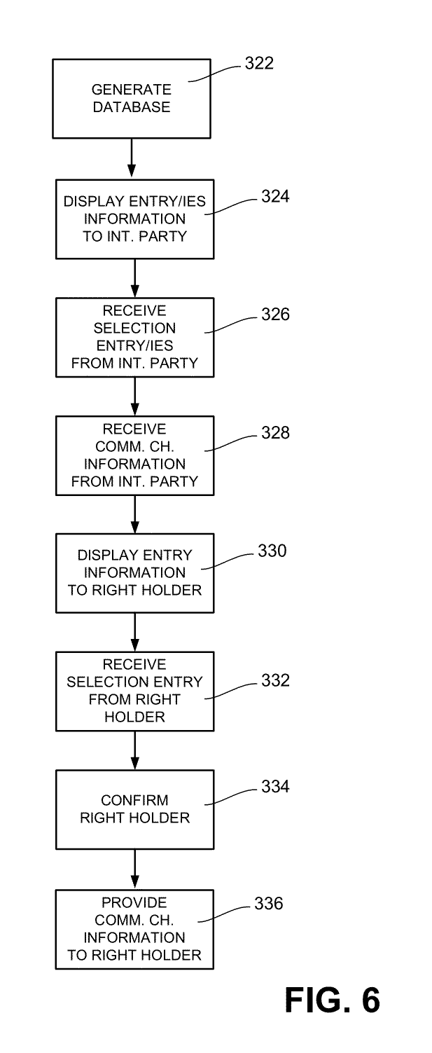

As reflected in FIG. 6, however, the method according to the present disclosure may begin with the generation of the database at block 322, and then include displaying information relating to the entry at a second remote computer at block 324, receiving from the second remote computer a selection of the entry at block 326, and receiving communication channel information from the second remote computer to permit a communication channel to be established with an interested party at block 328. Further, the method includes subsequently displaying information relating to an entry at a first remote computer at block 330, receiving from the first remote computer a selection of the entry at block 332, and confirming that the selection from the first remote computer originated with a right holder associated with the geographic location at block 334. Subsequently, the method may provide the communication channel information to the right holder at block 336, for example when it has been confirmed that the selection from the first remote computer has been received from the right holder. Such an order of steps may encompass the unsolicited order situations where the right holder has not even identified him or herself with the entry, and thus the geographic location and the real property thereof, prior to the selection of the entry by the interested party.

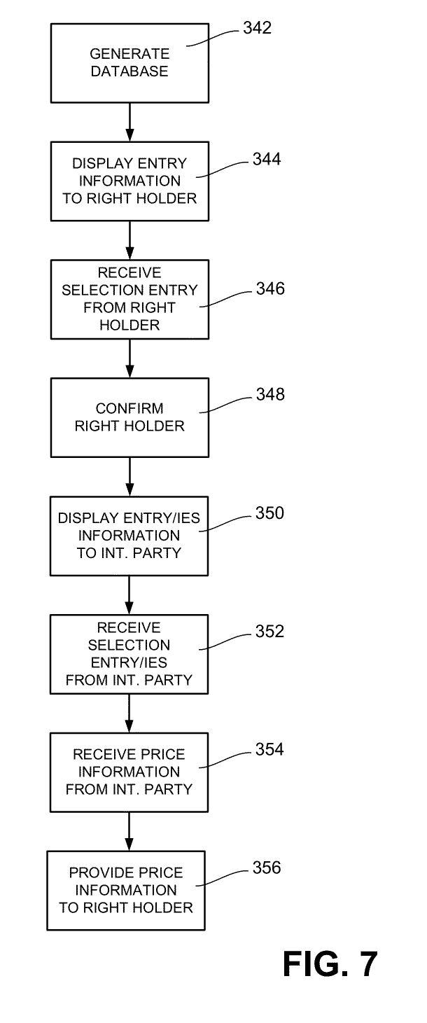

As further reflected in the method according to the present disclosure illustrated in FIG. 7, the method according to the present disclosure is not limited to facilitating communication by providing communication channel information (e.g., e-mail or SMS addresses, telephone numbers, or the like). In fact, the method may use the database 140 as the communication channel through the receipt, storage, and display of transfer price information in a particular field associated with the entry. For example, the method in FIG. 7, like the method in FIG. 5, includes generating a database at block 342, displaying information relating to an entry at a first remote computer at block 344, receiving from the first remote computer a selection of the entry at block 346, and confirming that the selection from the first remote computer originated with a right holder associated with the geographic location at block 348. The method subsequently includes displaying information relating to the entry at a second remote computer at block 350, receiving from the second remote computer a selection of the entry at block 352, and receiving transfer price information from the second remote computer at block 354. Subsequently, the method may provide the transfer price information to the right holder at block 356 at some point in time after the transfer price information has been received, with or without a prior request having been received from the right holder.

In fact, as part of the actions at block 356, the method may include storing the transfer price information associated with the geographic location in a transfer price field associated with the entry. Moreover, the method may include providing the right holder with the ability to edit the transfer price field associated with the entry, and modifying, subsequent to receipt of the transfer price information from the interested party, the transfer price field in response to an edit command received from the right holder to include transfer price information received from the right holder. As a consequence, when this information is subsequently displayed, the new transfer price information may be provided to the interested party.

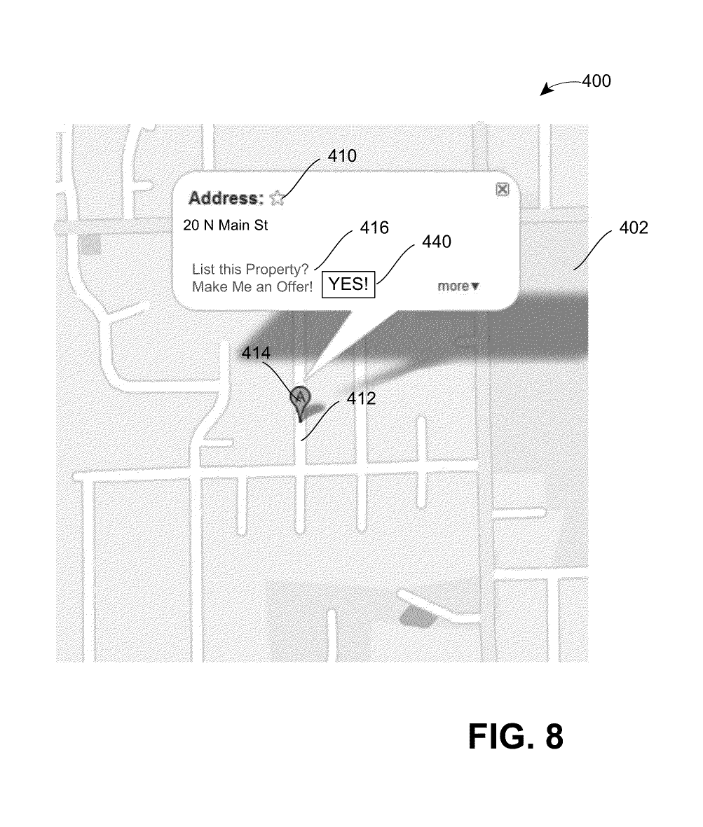

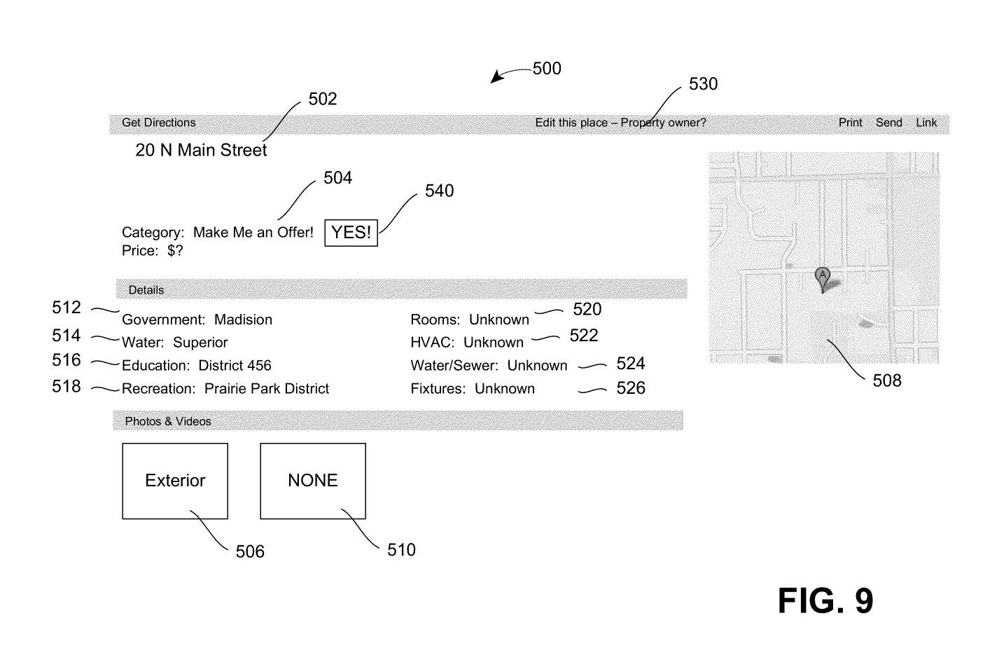

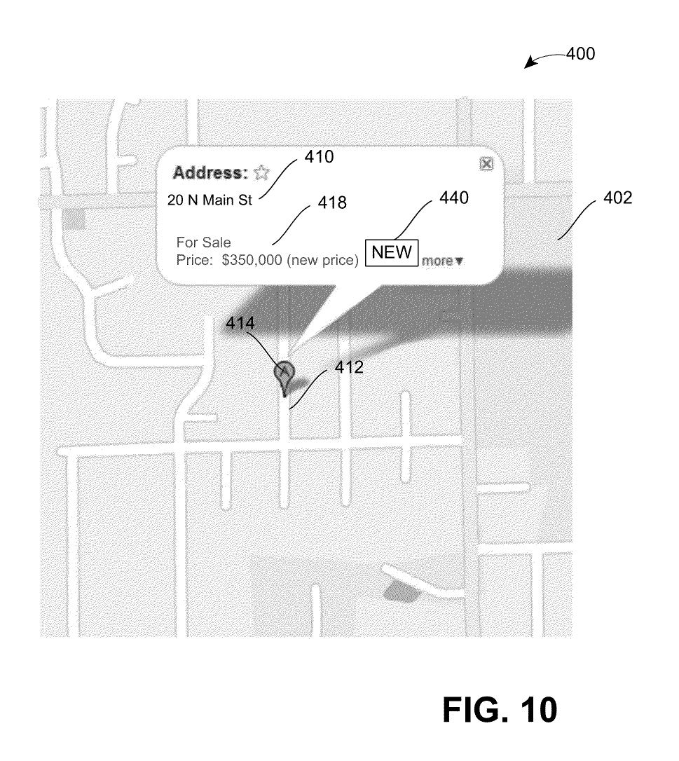

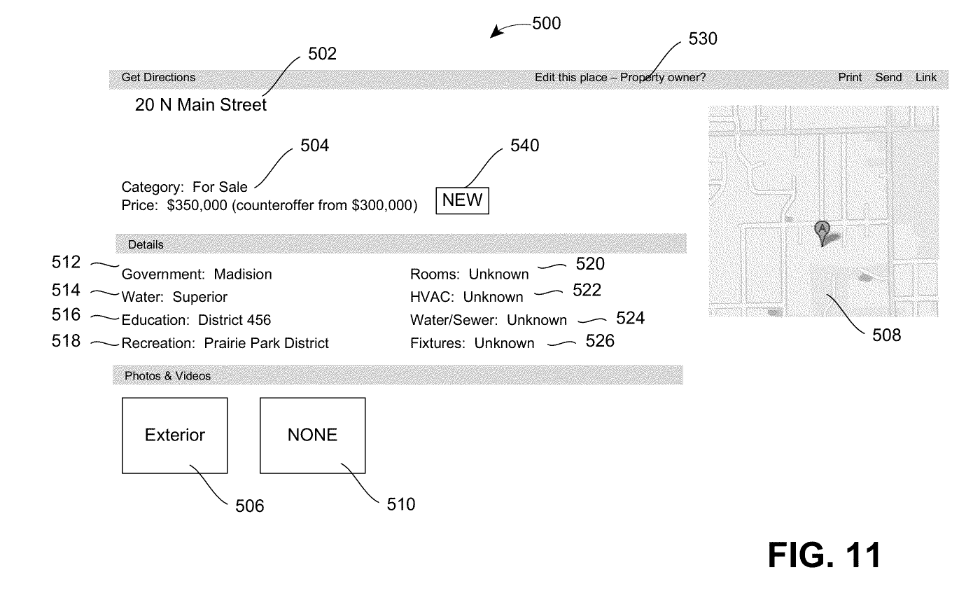

For example, the method according to the present disclosure may include displaying a map image including the geographic location, the map image including a link to a real property listing image at a location on the map image associated with the geographic location, the real property listing image having the potential to include the transfer price information received from the interested party or the right holder, as illustrated in FIGS. 8 and 9. In fact, the method may provide a visual cue to indicate that transfer price information initially received from the interested party has been updated to reflect transfer price information received from the right holder, as illustrated in various forms in FIGS. 10 and 11.

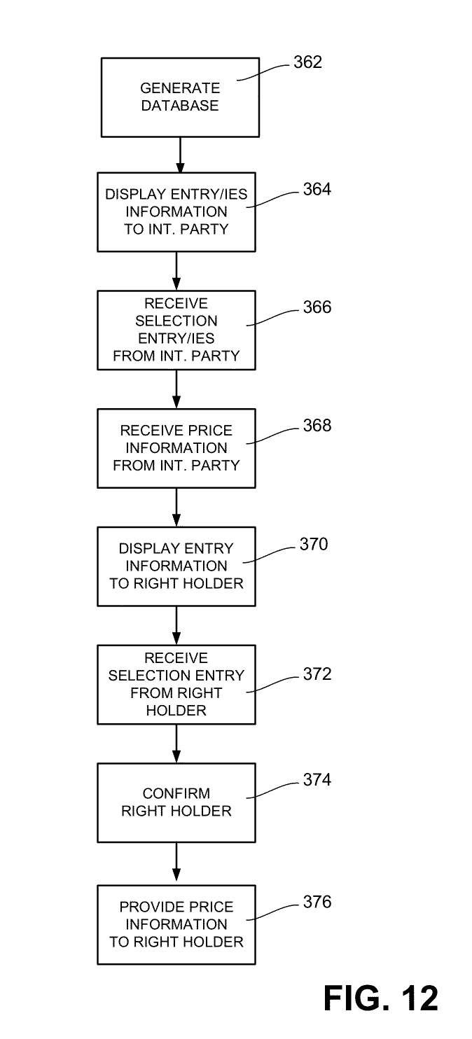

It will also be recognized that while FIG. 7 illustrates a form of the method wherein the right holder claims the entry prior to receipt of the transfer price information from the interested party, it is also possible for the right holder to claim the entry subsequent to the receipt of the transfer price information from the interested party, as illustrated in FIG. 12. That is, the actions of displaying the entry (block 364), receiving the selection of the entry (block 366) and receiving the price information (block 368) come before the actions of displaying the entry (block 370), receiving a selection of the entry (block 372), and confirming the right holder (block 374).

It will also be recognized that the receipt of the transfer price information by the system 110 does not require use of the database 140 as the exclusive communication channel, nor does it require the transfer price information to be displayed to the right holder through the use of the map image and the real property listing. In fact, subsequent to the selection of the entry by the interested party, the system 110 may receive both the communication channel information and the transfer price information from the interested party. The communication channel information and the transfer price information may be provided to the right holder through the storage and display of the information in the database 140. However, it is also possible for the communication channel information to be forwarded to the right holder, for example by way of e-mail or SMS, while the transfer price information is stored in the database 140 and displayed on the map image and the real property listing image, for example.

It will be further recognized relative to all of the embodiments illustrated in FIGS. 5-7 and 12 that the multiple entries may be displayed to the interested party, the interested party may select multiple entries, and the system 100 may receive communication channel and/or transfer price information regarding the multiple entries selected. In this fashion, one interested party may indicate their interest or intent to transfer rights from one or a plurality of real properties associated with a plurality of entries in the real property database 140. Consequently, the present disclosure is not limited to facilitating one-to-one communication or transfer opportunities, but may facilitate one-to-many or even many-to-many communication and transfer opportunities, for example through the use of a single agent acting as an interested party for multiple buyers or leasees.

Having thus described the system 100 and method according to the present disclosure in general terms, the various embodiments or variants will now be discussed in greater detail with the attached figures. As previously noted in all of the methods illustrated in FIGS. 5-7 and 12, the method begins with the generation of the database. See block 302 of FIG. 5, block 322 of FIG. 6, block 342 of FIG. 7, and block 362 of FIG. 12.

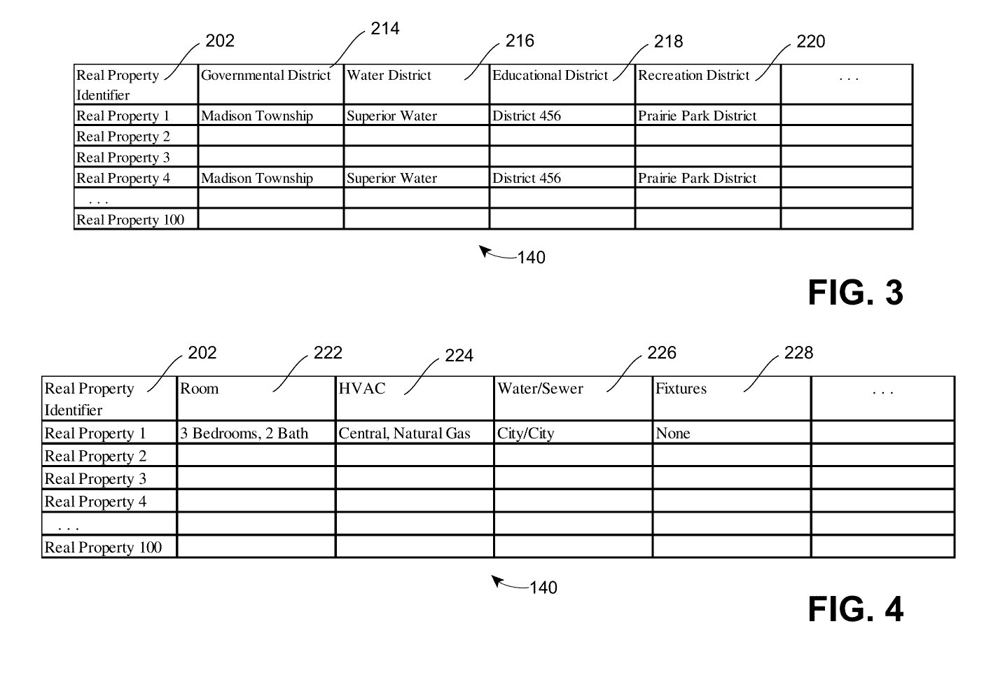

By way of example, an exemplary database 140 is illustrated in FIGS. 2-4. While a tabular representation has been established for the database 140 and used in FIGS. 2-4, no limitation is intended by this tabular representation, but it is used simply for ease of illustration. The database 140 may include a plurality of entries 200, each entry 200 representing an individual real property, as identified in a real property identifier field 202 of the database 140. In this regard as well, no limitation is intended by the use of the term “field,” for while such a term is generally used in regard to structured data, the present disclosure is also directed, for example, to embodiments where the specific attributes of an entry are represented as semi-structured data and may be designated using markup embedded in freeform text, such as using the Extensible Markup Language (XML) for example. Moreover, each entry 200 may represent an individual and unique real property according to certain embodiments. Furthermore, each entry 200 may include at least a geographic location field 204 containing information regarding a geographic location of the real property. One or more additional fields (e.g., a field 206) may also be included, as illustrated in FIG. 3.

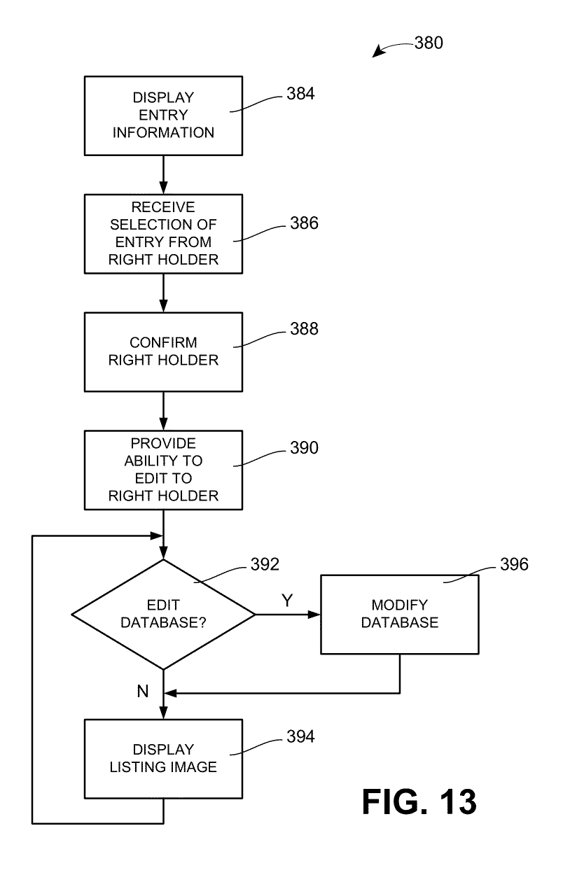

As noted with reference to any of FIGS. 5-7 and 12, at some point in the method according to the present disclosure, the method will include the steps of displaying entry information, receiving a selection of the entry, and confirming that the selection of the entry originated with the right holder. For example, see blocks 304-308 of FIG. 5, blocks 330-334 of FIG. 6, blocks 344-348 of FIG. 7, and blocks 370-374 of FIG. 12. While the disclosed method includes at least these steps, the disclosed methods may include additional steps as well relative to the right holder. To further explain the actions occurring at each of the steps occurring, for example, at blocks 304-308 in FIG. 5, as well as certain additional steps that may further be included in a method according to the present disclosure, reference is made to a method 380 illustrated in FIG. 13.

Presuming the generation of the database, common to all of the methods illustrated in FIGS. 5-7 and 12, the method 380 may begin at a block 384, wherein information relating to an unclaimed entry 200 representing a real property (e.g., Real Property 1, Real Property 2, etc.) having an ownership right that is transferrable from a right holder to a transferee and one or more additional editable fields (e.g., field 206) is displayed on a remote computer 120. According to the present disclosure, the real property may be a unit of land and/or an associated building. According to such an embodiment, the proposed transfer may include all legal rights to the real property (e.g., a fee simple). Alternatively, the real property may be a unit of a multidwelling building, such as a duplex or an apartment building. According to such a further embodiment, the proposed transfer may include all legal rights to the real property or may be a lease to the real property. Other embodiments are also possible, such as one in which there is no building on the unit of land, and the proposed transfer may be of the unit of land itself.

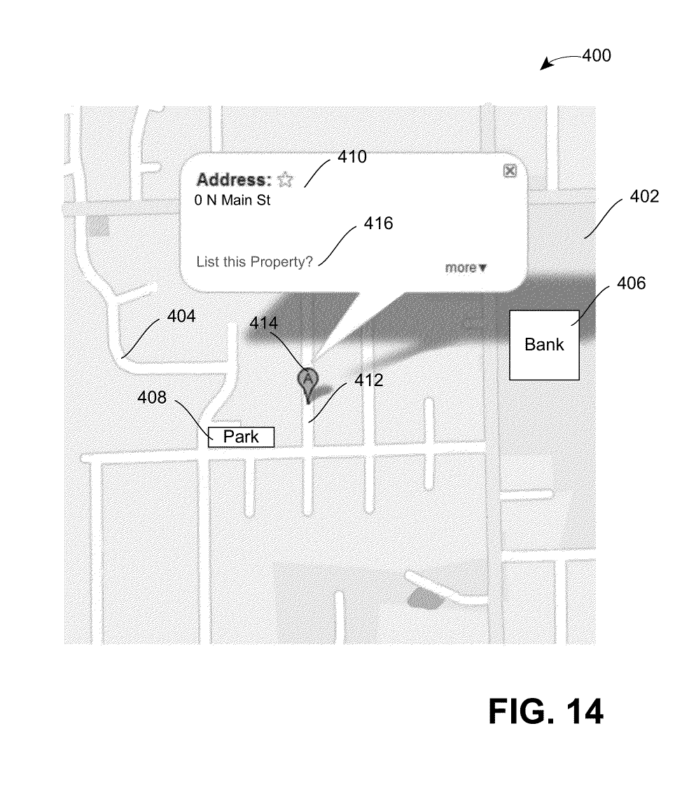

FIG. 14 illustrates an embodiment of an image 400 displayed to convey information regarding the unclaimed entry. The image 400 may include a map image 402 of a geographic region that includes a particular geographic location associated with a real property represented by an entry 200 in the database 140. The map image 402 may include illustrations of streets 404, commercial properties 406 and governmental properties, such as a park 408, although it may include illustrations of other items as well. The map image 402 may also include a link 410 to a real property listing image (to be discussed in greater detail hereinafter) at a location 412 on the map image 402 associated with the geographic location of the real property in question. In fact, the map image 402 may include a listing icon 414 at the location 412 on the map image 402 associated with the geographic location of the real property in question to highlight the availability of the link 410 to the real property listing image.

The right holder may access the image 400 in a number of different fashions. For example, the image 400 may be returned as the result of a query entered by the right holder into a search engine, with reference to a keyword or an address. Alternatively, the right holder may receive the image 400 as the result of navigating an interactive map display and arriving at the particular geographic location, whereupon the image 400 may be accessed using a pointing device (e.g., a mouse, touchpad, touchscreen, etc.) to interact with the interactive map display. It will be recognized that a combination of these actions may be used by the right holder to access the image 400.

The map image 402 of FIG. 14 may also include a link 416 that is particularly associated with the information as to an entry 200 representing a real property associated with location 412 on the map image 402. Selection of the link 416 causes a message to be sent from the computer 120 to the communication and editing system 110. The message sent from the computer 120 to the communication and editing system 110 when this link 416 is selected may be referred to as a selection. At some point after the message is sent, the communication and editing system 110 will receive the selection at block 386 of the method 380, and the method 380 will proceed to block 388.

The communication and editing system 110 will then take additional actions to confirm that the selection originated with the right holder associated with the geographic location who can transfer an ownership right to the real property associated with the entry 200 to a transferee. The act of confirmation, represented by the block 388 in FIG. 13, may be performed in a variety of fashions, and is not intended to guarantee that the right holder is in fact the right holder of the real property in question according to all embodiments. It is understood that whether the right holder is indeed the holder of the rights to the real property that the right holder, or more properly the presumed right holder, represents that he or she holds may be established during the legal process used to transfer the rights from the presumed right holder to the transferee. As such, according to certain embodiments of the present disclosure, the measures taken to establish that the right holder should be given the right to edit the entry for a particular property may not establish to a legal certainty that the right holder is indeed who he or she represents that they are and that the right holder does indeed hold the rights to the particular real property in question. However, according other embodiments, methods may be used that establish both of these facts to a legal certainty, and thus may be relied upon by those viewing the property listings. Obviously, the methods used to establish these facts will vary from jurisdiction to jurisdiction, but the implementation of these methods would fall within the scope of one of skill in the art. In any event, the party with rights to edit the entry for a property listing will be referred to as the presumed right holder herein, or right holder for short, without the limitation that steps have been taken that the right holder is the right holder as determined to a legal certainty.

For example, the party sending the selection to the communication and editing system 110 may be requested to provide a telephone number at which the party may receive a token via Short Message Service (SMS) or an e-mail address at which the party may receive a message. Upon receipt of the telephone number or e-mail address by the communication and editing system 110, the token will be sent to the telephone number or e-mail address of the party sending the selection if the telephone number or e-mail address is associated with the right holder. The right holder may then transmit the token to the communication and editing system 110 to complete the act of confirmation. Alternative methods may also be used, such as wherein the right holder must establish an account (potentially password-protected), and requiring the right holder to associate a phone number or a residential address or other information with the account to which an access code (which would function as the token) is transmitted/sent or to associate a credit card number with the account.

Once the act of confirmation is completed, the communication and editing system 110 may provide the right holder with the ability to edit the one or more additional editable fields associated with the real property (the entry 200) as represented by block 390 in FIG. 13. It will be recognized that by receiving the ability to edit the one or more additional fields, the right holder may not receive the ability to edit every field associated with the real property. According to certain embodiments, certain fields may be editable by only members of a particular class of users (e.g., database administrators) that do not include the right holder. For example, the real property identifier field 202 may not be editable by the right holder. Moreover, the ability to edit may not be coextensive with the right to delete material from the field according to certain embodiments. For example, the ability to edit may permit the right holder to add information to the field, but not delete the information already present. This arrangement may be desirable relative to a field for which it is important to preserve the history of changes made to the field to provide the ability to store and even display the evolution of the changes to a field over time.

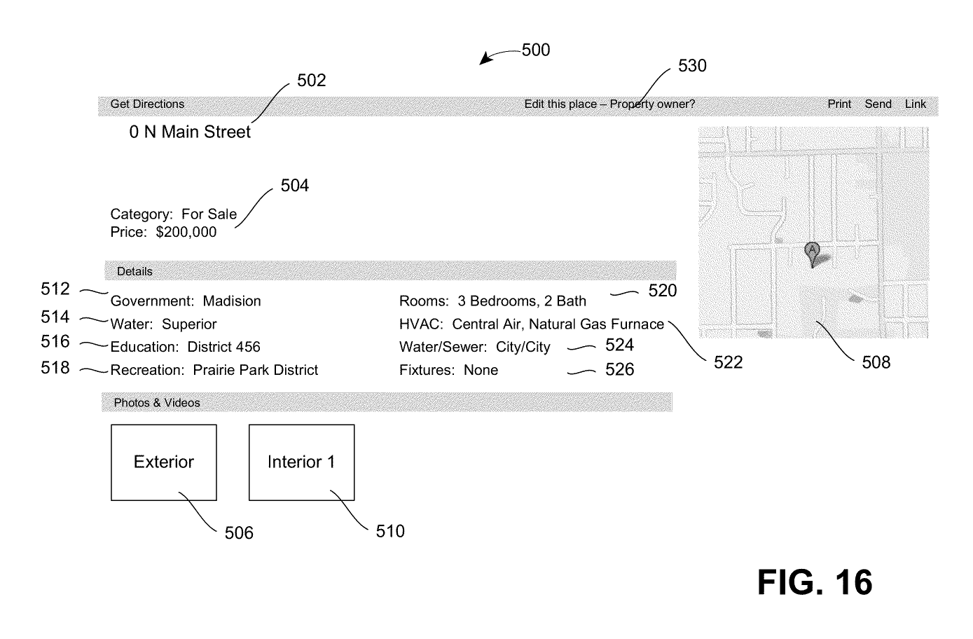

Subsequent to receiving the ability to edit the one or more additional fields, the communication and editing system 110 may then determine at block 392 whether the right holder wishes to edit the entry 200. If the right holder does not wish to edit the entry 200, the method 380 proceeds to the display of the real property listing image referred to previously. This is represented at block 394 in FIG. 13, and will be discussed in greater detail below with reference to FIG. 16.

However, the right holder may wish to modify the fields associated with the entry 200 representing the real property for which he or she is the right holder. Therefore, after the ability to edit has been provided to the right holder at block 390, the system 110 may determine at block 392 that the right holder wishes to modify one or more of the additional fields associated with the entry 200, for example through the receipt of an edit command. The system 110 may then modify the entry 200, and in particular one or more of the associated fields, as represented by block 396 in FIG. 13.

As one example, the right holder may send an edit command to the communication and editing system 110 to subsequently modify, for example, a transfer price field 206 (see FIG. 2). The transfer price field 206 may contain information regarding a transfer price associated with the geographic location, such as may be offered by an interested party for transfer of the ownership right of the real property from the right holder to the transferee. The communication and editing system 110 may then modify the transfer price field 206 for the entry 200 in question in response to the edit command received from the right holder to include or modify this information. As noted above, the transfer price field 206 may be one of those fields for which information may be added, but not deleted, so that the history and evolution of the price may be stored, and potentially even displayed.

In particular, with reference to entry 200 associated with Real Property 1 in FIG. 2, the transfer price field 206 may initially be blank. However, the interested party, after selecting the entry 200, or the right holder, after obtaining the ability to edit the entry 200, may decide to include or modify a transfer price for a transfer of some or all ownership rights to the real property from the right holder to an interested party (i.e., a buyer or the buyer's agent). As illustrated in FIG. 2, an interested party may have initially offered $180,000 for a transfer of the ownership right of the real property from the right holder associated with Real Property 1, which was subsequently modified to $200,000 by the right holder associated with Real Property 1. While a single transfer price field 206 of Real Property 1 has been illustrated in FIG. 2 as holding multiple values, it will be recognized that in addition to any field (e.g., the transfer price field 206) associated with an entry containing multiple items (e.g., transfer price values), a single entry may also have multiple instances of a single field (e.g., multiple instances of the transfer price field, one assigned each time a transfer price value is received) to store such data.

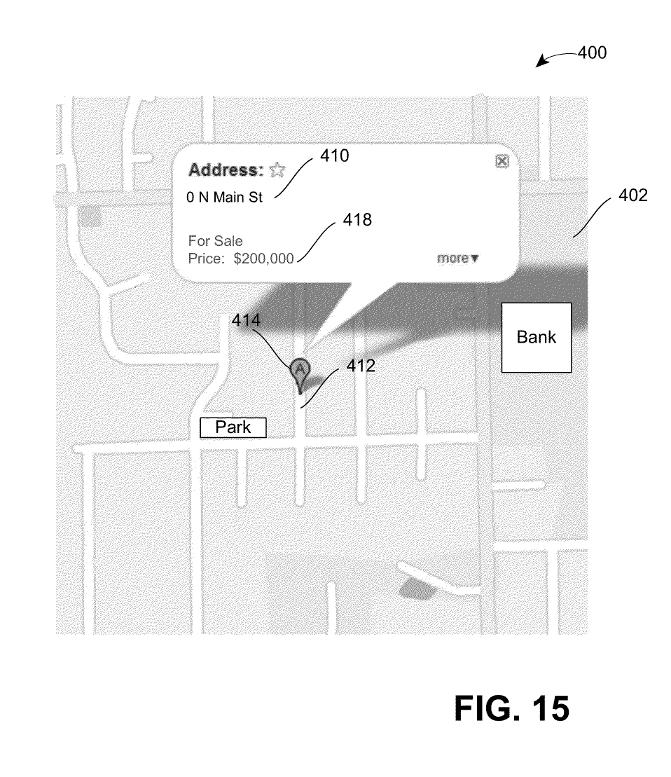

Once this modification of the entry 200 has taken place, the image 400 may also be modified, as illustrated in FIG. 15. In particular, while the image 400 includes the map image 402 and the link 410 at the location 412, along with the icon 414, the image 400 also includes a new link 418 with information obtained from the transfer price field 206. Specifically, the link 418 includes reference to the fact that the real property is “for sale” and that the right holder associated with the real property is willing to accept $200,000 for the transfer of all ownership rights in the real property from himself or herself to the transferee.

Of course, it will be recognized that the method as explained thus far is a simplified, but complete, disclosure of the information that may be associated in the database 140 with an entry 200 for a particular real property (e.g., Real Property 1) for which rights are to be transferred from one party to another: i.e., geographic location and transfer price. It will be further recognized that it is customary for additional information to be provided concerning a real property for which a transfer of ownership right is to occur. According to certain embodiments, this additional information may be included in fields associated with the entry 200 prior to the time the right holder can edit the real property listing. Alternatively, according to other embodiments, additional fields associated with the entry 200 may be modified at the request of the right holder (e.g., through the receipt of one or more edit commands via the communication and editing system 110). In either event, the information associated with the additional fields may cause further modifications to the image 400, or may even be displayed in the real property listing image associated with the link 410 displayed on the image 400 mentioned above and discussed in detail below.

As to information established prior to selection, the party that generated the database 140 may associate one or more exterior images of a building associated with the real property represented by the entry 200 in an exterior image field 208, in addition to generating the information included in the real property identifier and geographic location fields 202, 204. The exterior image(s) may be generated by the party that generated the database 140, or may be generated by a third party at the request and instruction of the party that generated the database 140. As a still further alternative, the exterior image(s) may be generated by a third party, and then the party that generated the database 140 may subsequently associate the exterior image with the entry 200 prior to the selection of the entry 200 by the right holder at block 306 of the method.

As illustrated in FIG. 2, one or more exterior images may be associated with the entry 200 in the exterior image field 208 through the association of a link to the exterior image in the field 208. Other alternative methods for associating the exterior image with a particular entry 200 and the exterior image field 208 may be adopted. As a consequence, the illustrated embodiment is simply an exemplary embodiment according to the present disclosure.

It will also be noted with reference to FIG. 2 that a real property listing image field 210 is also provided for each entry 200. The real property listing image field 210 and the associated real property listing image also may be generated prior to the selection of the entry 200 by the right holder. See, for example, the real property image listing fields 210 for the entries 200 associated with Real Property 2, Real Property 3, and Real Property 100, none of which have been accepted by the associated right holder but which include reference to real property listing images. According to the present embodiment, a real property listing image is generated for each of these entries 200 and associated with each of these entries 200 in the respective real property listing image field 210 prior to selection.

FIG. 16 is an illustration of a simulated screen shot of a real property listing image 500. The real property listing image 500 includes information that may be found in one or more of the fields associated with the entry 200 for this particular real property (Real Property 1). For example, the real property listing image 500 may include indicia (e.g., numeric, alphanumeric, or alphabetic characters) representative of information concerning the geographic location of the real property at 502, and indicia representative of information concerning the transfer price at 504. The image 500 may also include images, such as the one or more exterior images 506 as well as a map image 508 that identifies the geographic location of the real property in question relative to streets, commercial properties and governmental properties. Moreover, the information displayed may include all, part or none of the information stored in a particular field of the entry 200 (e.g., only the most recent transfer price may be displayed according to an embodiment of the present disclosure where the right holder may edit the transfer price field 206 only by adding to the information previously entered). Additional information may be displayed on the image 500 as will be explained in greater detail with the further embodiments discussed herein.

In addition to the pre-established information (i.e., information associated with the fields of the entry 200 prior to selection by the right holder), the fields may also include information that was associated with the fields in response to edit commands received from the right holder. Like the pre-established information included in the fields, the information included in response to edit commands from the right holder may be further reflected in modifications of the real property listing image 500.

As seen in FIG. 2, the database 140 may include an interior image field 212, in which is included information associating one or more interior images of a building located on the real property in question with an entry 200 representing that real property. Unlike the exterior image(s), which may be provided by the party generating the database 140 or a party acting on their behalf, the interior images(s) of the building on the real property will most likely be provided by the right holder or a party acting on behalf of the right holder. Thus, the communication and editing system 110 will most likely modify the interior image field 212 in response to an edit command received from the right holder to associate the interior image(s) with the entry 200. It will also be recognized that while an exterior image field 208 and an interior image field 212 have been introduced with respect the illustrated embodiment, this should not be seen as precluding additional image fields, or an embodiment including a single image field that associates exterior, interior, and other images.

According to the present disclosure, the interior images associated with the entry 200 by the interior image field 212 may be included in the real property listing image 500. For example, as illustrated in FIG. 16, the real property listing image 500 may include the one or more interior images of the building associated with the real property at 510, in addition to including indicia representative of the geographic location of the real property and the transfer price at 502, 504, for example.

The database 140 may include further information in additional fields associated with each of the entries 200. Certain exemplary fields are illustrated in FIGS. 3 and 4. Fields containing information that may be obtained from public sources are included in FIG. 3 and are likely to include pre-established information according to certain embodiments, while fields containing information that will likely be available only from the right holder are included in FIG. 4, although these fields may include pre-established information according to certain embodiments as well. As noted above, information associated with these fields may be included in the real property listing image 500, as were the interior images at 510.

For example, FIG. 3 illustrates four additional fields 214, 216, 218, 220 associated with the real property. According to the present disclosure, the field 214 may contain information representative of a governmental district (e.g., city, township, etc.) in which the real property is located. The field 216 may include information on a water district that provides water service to the real property; in a situation where the real property has its own water supply (e.g., well), this field may include an identifier of this fact as well. The field 218 may include one or more educational districts associated with the real property, for example public primary and secondary educational districts. Further, field 220 may include information on a recreation district, such as a park district, associated with the real property. According to such an embodiment, the communication and editing system 110 may modify the one or more additional fields 214, 216, 218, 220 in response to an edit command received from the right holder to include information representative of one or more of a government district, a water district, an educational district, and a recreation district.

The information thus stored in the database may subsequently be displayed in the real property listing image 500. For example, the real property listing image 500 may including indicia representative the government district at 512, the water district at 514, the educational district at 516, and the recreation district at 518, in addition to indicia representative of the geographic location of the real property and the transfer price at 502, 504. As a consequence, a party viewing the image 500 may obtain additional information regarding the real property from the real property listing image 500 at a glance.

FIG. 5 also illustrates four additional fields 222, 224, 226, 228 associated with the real property, although as mentioned previously these fields generally relate to information that may not be of public record relative to the real property. According to the present disclosure, the field 222 may contain information representative of the number of rooms and/or the type of rooms associated with the real property. For example, the field 222 may include reference to the number of bedrooms, bathrooms, and other living spaces. The field 224 may include information regarding the heating, ventilation, and air conditioning (HVAC) equipment associated with the real property. For example, the field 224 may include reference to whether the heating is generated by a gas-fired furnace or an electrical heater, or if central air conditioning is included. The field 226 may include information regarding the water and sewer connections, and may thus overlap to a certain degree with the water district field 216 in that properties obtaining their water from a pump may be designated differently from those obtaining water through a city water connection. Finally, the field 228 may include information on fixtures provided with the real property, such as refrigerators, dishwashers, stoves and other items that would be transferred with the real property, or more particularly a building located on the real property. According to one embodiment, the communication and editing system 110 may modify one or more of the fields 220, 222, 224, 226 in response to an edit command received from the right holder to include information representative of a room description, a HVAC description, a water/sewer description, and a fixture description, for example.

The information thus stored in the database 140 may subsequently be displayed in the real property listing image 500. For example, the real property listing image 500 may include indicia representative of the room description at 520, the HVAC description at 522, the water/sewer description at 524, and the fixture description at 526, in addition to indicia representative of the geographic location of the real property and the transfer price at 502, 504.

Having thus described the system 100 and the method 380 in general terms, a specific illustration of the operation of the system 100 and method 380 is now discussed, again with reference to FIGS. 2-4 and 13-16. This illustration involves the use of the real property database 140 with its plurality of entries, each entry representing a real property. As illustrated in the tabular representation of the database 140 in FIGS. 2-4, this database includes at least one hundred different properties arranged along one street. It will be recognized that according to the present disclosure, because the database 140 included in other embodiments may include millions of properties in thousands of municipal organizations around the world, the illustrated database 140 is has been limited primarily to simplify the discussion of the illustration.

As initially generated, the database 140 according to this illustration included information in the real property identifier field 202, the geographic location field 204, the exterior image field 208 and the real property listing image field 210. For example, such a database 140 may be established as part of the Google Maps service, wherein each individual real property may be provided with a unique real property identifier and associated with a particularized geographic description, and then an exterior image may be associated with the real property identifier as part of the Streetview service provided by Google Inc. of Mountain View, Calif. Moreover, a real property listing image 500 may be generated by assembling a webpage from the foregoing information in fields 202, 204, 208, and this image 500 may also be associated with the entry 200 using the field 210.

According to this particular illustration, the communication and editing system 110 in communication with the database 140 and one of remote computers 120 may be programmed to carry out the above-mentioned method 380 relative to a right holder, for example the right holder (owner) of the real property located at 0 N Main (Real Property 1). The system 110 may begin (such as at block 384) by displaying at the remote computer 120 information relating to an unclaimed entry 200 representing Real Property 1 by displaying on the remote computer 120 the image 400 illustrated in FIG. 14. This image 400 may be displayed in the course of events of providing a separate service, such as the Google Maps service, or the image 400 may be displayed in response to a request received from the right holder.

Upon viewing the information, as represented by the image 400, the owner of Real Property 1 may select the entry (block 386). This process may also be referred to as claiming the entry 200. To do so, the owner of Real Property 1 may activate the link 416, which causes the system 110 to receive from the remote computer 120 a selection of the entry 200 for Real Property 1 (block 388).

As mentioned above, once a selection is received by the system 110, the system 110 may be programmed to confirm that the selection originated with the right holder (in this case, the owner) of Real Property 1 before providing the owner with the ability to edit the fields associated with the entry representing Real Property 1 (block 388). For example, the system 110 may use the afore-mentioned SMS method to exchange a token with the owner, which token the owner may use to confirm his or her identity to the system 110. Of course, other methods may be used to ensure the identity of the owner. Once confirmation has been received, the system 110 may provide the owner with the ability to edit the one or more additional fields 206, 210, 214, 216, 218, 220, 222, 224, 226, 228 associated with the entry 200 for Real Property 1 (block 390).

For example, the owner may begin by sending an edit command to modify the transfer price field 206 in FIG. 3 (block 392). As illustrated, the owner has caused the transfer price field 206 to be modified from $180,000 such that it now contains information that the owner is willing to sell Real Property 1 for $200,000. The user interface used to produce the edit command received by the system 110 to cause this modification to be made to the database 140 may vary according to the implementation of the system 100 and method 380, and with respect to the computer 120 as well. However, whatever the interface used, the system 110 receives the edit command and modifies the database 140 to store information that can be used by the system 110 to communicate to others that the owner is willing to accept $200,000 for Real Property 1 (block 396).

Proceeding on with the method 380, the owner may provide further edit commands to complete other fields associated with the entry 200 associated with Real Property 1 (again, block 392). For example, the owner may have one or more interior images of the building associated with Real Property 1 that the owner would like to have associated with the entry 200 for Real Property 1. As a consequence, the system 100 may receive an edit command to modify the interior image field 212, which edit command involves uploading one or more interior images from the computer 120 to the system 110, and potentially the database 140, and associating those uploaded images with the interior image field 212 of the entry 200 for the Real Property 1.

In fact, as illustrated in FIGS. 3 and 4, the owner of Real Property 1 may provide additional edit commands to cause information to be included or stored in each of the fields 214, 216, 218, 220, 222, 224, 226. For example, the owner may provide and the system 110 may receive edit commands to include “Madison Township” with the governmental district field 214, “Superior Water” with the water district field 216, “District 456” as the primary education district in educational district field 218, and “Prairie Park District” with the recreational district field 220. In addition, the owner may provide and the system 110 may receive edit commands to include “3 Bedroom, 2 Bath” with the room field 222, “Central, Natural Gas” for central air conditioning and a natural gas furnace with the HVAC field 224, “City/City” for city water and city sewer in the water/sewer field 226, and “None” in the fixture field 228.

While the owner of Real Property 1 chose to cause each of the fields associated with the entry 200 for Real Property 1 to be modified, this is not a requirement of the present disclosure. For example, after the right holder for Real Property 4 (located at 20 N Main) selected the entry associated with Real Property 4, he or she did not elect to upload and associated images with the interior image field 212. As such, the system 100 and method 380 according to the present disclosure permit considerable flexibility to the actual information stored in the database 140, while providing an organized and standardized set of possible types of information to be stored, when desired.

According to the illustration, the information stored in the database 140 by the owner of Real Property 1 may be displayed in a variety of fashions through the images in FIGS. 15 and 16 (block 394). For example, as noted previously, the original image 400 that was used by the system 110 to convey the information to the right holder to claim the entry 200 and its associated fields and real property listing image 500 may also be used to display information included in the database 140. As illustrated in FIG. 15, information from the transfer price field 206 may be displayed as indicia in image 400 that conveys to the viewer that the right holder for the real property at the location 412 on the map image 402 would be willing to accept $200,000 to transfer ownership of the real property.

In the alternative, one viewing the image 400 may use the link 410 to access the real property listing image 500, illustrated in FIG. 16. Again, the information included in the database 140 may be displayed as part of the image 500. In particular, the image 500 includes information from all of the fields 204-224 previously mentioned. Thus, one viewing the image 500 may determine the geographic location of the real property at 502 and the transfer price at 504. The party viewing the image 500 may also be able to view images at 506, 510 of the exterior and interior of the building located on the unit of land associated with the real property. Furthermore, indicia may be provided to communicate information about the governmental, water, educational, and recreational districts associated with the real property at 512, 514, 516, 518, respectively. Furthermore, indicia may be included in the image 500 relative to the building associated with the real property, such as the number and type of rooms (at 520), the air conditioning and furnace (at 522), the water and sewer connections (at 524), and the fixtures to be transferred with the building (at 526).

It will be recognized that modifications may be made at any time to the database 140 by the right holder once the right holder has selected the entry, thus claiming the real property listing. It will also be recognized that the modifications to the database 140 may be reflected in changes to the images 400, 500 simultaneously or contemporaneously with the modifications to the database 140. For example, if the owner wished to change the sale price for the real property, the owner could use the link 530 on the real property listing image 500 to access the communication and editing system 110, and to send an edit command to the system 110 to modify the information associated with the transfer price field 206 for the entry 200 associated with Real Property 1. For instance, the owner may decide to decrease the sale price from $200,000 back to $180,000. The owner may consequently send an edit command to the system 110 to make this modification to the database 140 at the field 206. With the information at the field 206 thus updated, the indicia in the images 400, 500 at 418, 504 would be altered from “$200,000” to “$180,000” to reflect the change in sale price.

For that matter, while numerical indicia are displayed at 418, 504 in the images 400, 500, it is possible for the owner to use an edit command to change the information displayed at 418, 504 (by changing the information stored at transfer price field 206) to display alphanumeric or alphabetic characters. For example, if the owner receives a contract for to transfer the real property at the requested transfer price, “Under Contract” may be displayed at 418, 504 in response to a modification of the field 206. As a further alternative, the owner may modify the field 206, and thus the images 400, 500, to reflect the completion of the sale of the real property.

Having thus described the actions of the right holder that may occur, for example, at blocks 304-308 of FIG. 5, blocks 330-334 of FIG. 6, blocks 344-348 of FIG. 7, and blocks 370-374 of FIG. 12, the actions of the interested party such as may occur at blocks 310-314 of FIG. 5, 324-328 of FIG. 6, 350-354 of FIG. 7, and blocks 364-368 of FIG. 12. Again, this is done with reference to the database illustrated in FIGS. 2-4, and additionally with reference to the images illustrated in FIGS. 8-11.

As illustrated in FIG. 5, for example, one or more entries may be displayed to the interested party at block 310. The one or more entries displayed to the interested party may be initially selected based on a search assembled and executed by the interested party. In particular, the system 110 may receive a search request from the second remote computer 120 used by the interested party. The system 110 may then collect a set of entries from the plurality of entries according to the search request. The set of entries may include only a single entry, but the set may also include a plurality of entries as well. The system 110 may then cause the information regarding the set of entries to be displayed at the second remote computer 120.

As to the search request received by the system 110 from the interested party, the search request may include terms associated with a particular a geographic region, or a plurality of geographic locations. For example, the search request may be directed to a particular city or town, or a division of or neighborhood within a city or town. Alternatively, the search request may include a characteristic of the real property associated with or defined by the geographic location. For example, the search request may be directed only at geographic locations featuring single family dwellings, multi-family dwellings (e.g., apartments or duplexes), or commercial properties. The search request may also be based on a characteristic of a real property right, for example an estimated transfer price or range of transfer prices for the real property located at particular geographic locations associated with the entries in the database, which estimated transfer price or range of transfer prices may be generated based on a survey of transfer prices for similarly situated real properties in a geographic region. Further, the search request may include terms selected to identify only those entries where the system 110 has received from the right holder an indication of interest in transferring one or more of the real property rights associated with the geographic location.

Alternatively, the one or more entries may be displayed to the interested party as a consequence of the interested party accessing a map image. For example, the system 110 may cause the remote computer 120 to display a map image 400 including the geographic location (see FIG. 8 or 10), the map image 400 including a link 410 to a real property listing image 500 (see FIG. 9 or 11) at a location on the map image 400 associated with the geographic location 412. This real property listing 500 may include information from one or more fields associated with an entry 200 (see FIGS. 2-4). The map image 400 may include a listing icon 414 at the location 412 on the map image 400 associated with the geographic location to highlight the link 410 to the real property listing image 500, the listing icon 414 including the information associated with the entry 200.

To facilitate the review and selection of the entry 200 by the interested party, the map image 400 and/or the real property listing image 500 may include information obtained from the database 140 for the entry 200 in question. At a minimum, the information may include the geographic location, stored in field 204, associated with the entry 200. Alternatively, the map image 400 may include other information, such as an estimated transfer price for the property, which estimated transfer price for the property may be provided by a third party based on transfer prices for comparable real property rights within a particular geographic region, such as was described above and may be stored in the transfer price field 206. In fact, the map image 400, and in particular the information displayed at 440 of FIG. 8, may include an indication of interest to transfer the rights associated with the geographic location received from the right holder (“Make me an offer!”). This indication of interest may be associated with or may be defined by a display, whether in the map image 400 or the real property listing 500, of a transfer price requested by the right holder to transfer the rights associated with the geographic location received from the right holder. In fact, the display of the listing icon 414 may modified to reflect the indication of interest and/or the transfer price (the indication of interest, according to certain embodiments, defined by the transfer price) through the use of shape or color, for example. According to other embodiments, an indication of interest to transfer the property may be displayed for any property for which a transfer price has not been received from an interested party or the right holder (e.g., “Make me an offer!”).

Moreover, as noted above and will be observed in FIGS. 5 and 7, the selection of the entry 200 may be received from the second remote computer 120 associated with the interested party after the selection of the entry 200 is received from the first remote computer 120 associated with the right holder and the selection from the first remote computer 120 is confirmed to originate with the right holder of associated with the geographic location (compare, e.g., blocks 312 and blocks 306, 308 in FIG. 5). Alternatively, as illustrated in FIGS. 6 and 12, the selection of the entry 200 may be received from the second remote computer 120 associated with the interested party before the selection of the entry 200 is received from the first remote computer 120 associated with the right holder and the selection from the first remote computer 120 is confirmed to originate with the right holder of associated with the geographic location (compare, e.g., blocks 326 and blocks 332, 334 in FIG. 6).

Even though the selection of the entry 200 may be received from the interested party before the selection of the entry 200 is received from the right holder, the real property listing image 500 as illustrated in FIG. 9, for example, may include additional information regarding the real property, other than simply the geographic location. For example, as illustrated in FIG. 9, the listing image 500 may include exterior images 506 stored in the database 140 in the exterior image field 208. As simply one example, these exterior images 506 may be obtained from the Streetview service provided by Google Inc. of Mountain View, Calif. Additionally, information obtained from publically available sources may also be displayed at 512, 514, 516, 518, as retrieved from the database at fields 214, 216, 218, 220 (see FIG. 3). Other parts of the listing image 500 may not be completed at the time the interested party selects the entry (see, e.g., 520, 522, 524, 526), although this information may also be included, for example, where the real property associated with the geographic location 412 has been offered for sale by the present right holder or a previous right holder in the past.

After the information regarding one or more entries 200 has been displayed to the interested party at block 310 and one or more selections of entries 200 have been made at block 312, the system 110 may receive information from the interested party. According to the embodiment of the method according to the present disclosure illustrated in FIGS. 5 and 6, this information may include communication channel information (see block 314 of FIG. 5, for example). This communication channel information may include, e-mail or SMS addresses, telephone numbers, or the like. According to the embodiment of the method according to the present disclosure illustrated in FIGS. 7 and 12, this information may include transfer price information, which as explained above, may be used according to the present disclosure to open a communication channel through or using the database 140 (see block 354 of FIG. 7, for example). According to still other embodiments, both the communication channel information and the transfer price information may be received from the interested party.

If communication channel information is received from the interested party, it may be stored in the database 140 in the communication channel field 205. If transfer price information is received from the interested party, it may be stored in the database 140 in the transfer price field 206. As indicated above, the transfer price field 206 for the entry 200 associated with Real Property 1 may reflect a situation where a transfer price of $180,000 was received from an interested party, and subsequently a right holder modified the transfer price to $200,000. These actions may be part of an instance where the interested party is using the database 140 as the communication channel, as there is no communication channel information stored in the communication channel field 205. Alternatively, communication channel information has been stored in the communication channel field 205 associated with the entry 200 for Real Property 2, but no transfer price information, which suggests that the interested party has indicated his or her preference to use a communication channel separate and apart from the database 140 to communicate regarding the transfer of the real property rights associated with the real property located at the geographic location (“10 N Main”) associated with Real Property 2. As a still further alternative, both communication channel information and transfer price information has been stored in the fields 205, 206 with respect to the entry 200 associated with Real Property 4.

As the method passes to block 316 of FIG. 5 or block 356 of FIG. 7, the information received from the interested party (potentially stored in the database 140) is provided to the right holder. This action may be performed in a number of different ways.

As one example, the communication channel information or transfer price information may be provided the right holder by retrieving the communication channel information or transfer price information, and then displaying the communication channel information or transfer price information to the right holder. In particular, the information may be displayed as part of the images 400, 500. As noted above transfer price information may be displayed as part of a map image 400 including the geographic location 412, the map image 400 also including a link 410 to a real property listing image 500 on the map image 400 associated with the geographic location 412. The real property listing image 500 may include the transfer price information received from the interested party (at 504), as may the map image 400. In particular, a listing icon 414 may be displayed at the location on the map image 400 associated with the geographic location 412 to highlight the link to the real property listing image 500, the listing icon 414 including the transfer price information received from the interested party.

As a further example, this display may be performed separate and apart from the display of the information in the images 400, 500, as illustrated in FIGS. 8 and 9. According to one such embodiment, a separate window may open when the right holder accesses the image 500, wherein the communication channel information or transfer price information is displayed. For example, an agent of the transferee may be less concerned about the visibility of the communication channel information when displayed as part of the image 400, 500, and may actually prefer to have it known that they are in the market for a particular type of real property right as would be obtained through visual inspection of a map image wherein their communication channel information is displayed with multiple geographic locations 412.

When the communication channel information or transfer price information is received, the system 110 may alert the right holder that the communication channel information or transfer price information has been stored prior to retrieving and displaying the communication channel information or transfer price information. For example, the system 110 may send the right holder an SMS message letting the right holder know that information regarding an interested party and/or transfer price is stored in the database 140 without sending the entirety of the information received from the interested party. Alternatively, the system 110 may wait to receive a selection of the communication channel information or transfer price information from the right holder prior to retrieving and displaying the information. This may occur, as noted above, wherein the communication channel information is to be displayed in a separate display (e.g., window) to the right holder and only the right holder to preserve the privacy of the communication channel information and confidentiality of interested party.

As a still further alternative, the system 110 may forward the communication channel information or transfer price information to the right holder. Similar to the variant described above wherein an alert is sent to the right holder prior to retrieving and displaying the communication channel information, the information may be sent directly to the right holder, to a specified e-mail account associated with the right holder, for example. It will be recognized that the method by which the communication channel information is sent to the right holder may or may not be the same as the communication channel selected by the interested party for future communications regarding the transfer of the real property rights.

Having thus described the system 100 and the method in general terms, specific instances of the operation of the system 100 and method are now discussed, again with reference to FIGS. 2-4 and 5-12.

According to one instance, an interested party locates a real property before the property owner has claimed the entry corresponding to that property. In this instance, the real property is located at the geographic location associated with the entry 200 also identified as Real Property 4 in real property identifier field 202. As reflected in the database 140, certain portions of the entry 200 associated with Real Property 4 include information stored regarding Real Property 4. For example, information has been stored in regard to the geographic location field 204, the exterior image field 208, the governmental district field 214, the water district 216, the educational district 218, and the recreation district 220. This information may be included in the database from sources available to the party that generates the database 140. In particular, the external image information may be obtained from Streetview service provided by Google Inc. of Mountain View, Calif. Other information may be obtained by cross-referencing the geographic location information to publicly-available databases.

FIGS. 8 and 9 represent a map image 400 and a real property listing image 500 corresponding to Real Property 4, which is the real property associated with the geographic location identified in the database 140 as Real Property 4 in the real property identifier field 202. As a consequence, when first viewed by the interested party, the map image 400 would include information regarding the geographic location and may also display a standard (or default) greeting message established by the party providing the service according to the disclosed method. The message may be neutral or empty (null set), or the message may invite interested parties to make offers for the property rights associated with the entry even though the right holder associated with the real property and real property rights associated with the geographic location has not yet claimed the entry or indicated his or her interest in offering the real property rights for transfer. As illustrated, the map image 400 includes a “Make Me an Offer!” message to encourage use of the system 100 and method according to the present disclosure although the entry 200 associated with Real Property 4 has not yet been claimed or interest indicated by the right holder.

In regard to the real property listing image 500, this may include the information displayed in the map image 400, as well as the other information stored in the database 140 associated with the entry 200 for Real Property 4. In addition, the real property listing image may also include a standard greeting message similar to that displayed in the map image 400 (e.g., “Make Me an Offer”) at 504. Other features of the real property listing image 500 have been discussed with reference to method 380, above.

After viewing the displayed information regarding the entry, the interested party may select the entry, which selection may be received by the system 100 through a number of different mechanisms and methods. As illustrated, the map image 400 and the real property listing image 500 both include a link 440, 540 that an interested party may select (through the use of an input device, such as a mouse, touchpad or touch screen, for example) to express their selection of the entry 200 identified with a particular real property associated with a particular geographic location. Once the link has been selected, the system 100 is prepared to receive information from the interested party.

As reflected in the database 140 (although not reflected in the images in FIGS. 8 and 9), the interested party that selected the entry 200 associated with Real Property 4 provided both communication channel information (in the form of an e-mail address) and transfer price information (i.e., $300,000). Upon receipt of this information by the system 100, the system 110 may store the information in the database 140. Furthermore, according to the present embodiment, the communication channel information may be forwarded or transmitted directly to the right holder (upon identification and confirmation of the right holder), while the transfer price information may be displayed as part of the images 400, 500.

As reflected in FIGS. 10 and 11, at some time after the interested party enters his or her communication channel information and transfer price information, the right holder claims the entry 200 associated with the Real Property 4. Upon doing so, the right holder may provide additional information regarding the real property associated with Real Property 4 in the database 140. Moreover, as reflected in the images 400, 500, the right holder has modified the transfer price information in the transfer price field 202 to reflect the right holder's desired transfer price of $350,000. Moreover, the images 400, 500 have been modified to include a message (e.g., “(new price)” in FIG. 10) or other indicator that would permit a party viewing the image 400, 500 to determine that the transfer price has been changed by either an interested party or the right holder. The link 440, 540 may also be updated to reflect the change in transfer price, and to permit the interested party to further modify the transfer price field.

The modification of the transfer price by the right holder may be communicated to the interested party when the interested party next views the images 400, 500. Alternatively, the right holder may use the communication channel information stored in the communication channel field and provided to the right holder to communicate the existence and/or substance of the modification to the interested party. In fact, in a situation where there are multiple interested parties, the right holder may use communication channel information received by the system 100, stored in the database 140, and provided to the right holder by the system 100 to contact each of the interested parties. As a further alternative, the system 100 may automatically use communication channel information received from the interested party, when provided, to alert the interested party to the modification of the transfer price made by the interested party.

Other modifications will be recognized, relative to the method and the system. For example, the networks 130 may include, by way of example but not by way of limitation, any combination of a LAN, MAN, WAN, mobile, wired or wireless network, a private network, or a virtual private network. While only three remote computer 120 are shown to simplify the disclosure, it will be recognized that very large numbers of computers 120 may be supported and in communication with the communication and editing system 110.

Both the communication and editing system 110 and the computers 120 may include a processor, a memory, a network interface, peripheral interfaces, and other well known components. As will be recognized, other types of computers can be used that have different architectures. The communication and editing system 110 and the computers 120 may also be adapted to execute computer program modules for providing functionality described herein. As used herein, the term “module” refers to computer program logic used to provide the specified functionality. Thus, a module can be implemented in hardware, firmware, and/or software. In one embodiment, program modules are stored in on a storage device, loaded into memory, and executed by a processor or can be provided from computer program products that are stored in tangible computer-readable storage mediums (e.g. RAM, hard disk, or optical/magnetic media).

Alternatively, many other configurations are possible. For example, the database 140 may be physically located within the communication and editing system 110. As further alternatives, the database 140 may be stored in external storage attached to communication and editing system 110, placed within one of the computers 120, or stored in network attached storage. Additionally, there may be multiple communication and editing systems 110 that connect to and are in communication with a single database 140.

Along similar lines, it will be recognized that although the preceding text sets forth a detailed description of different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

Further, to the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph. In addition, it should be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims).

In relation to this application, real property refers to property other than personal property. In this regard, real property may be understood as referring to immoveable property in those jurisdictions that make a distinction for purposes of property law between moveable and immovable property. Real property may also be used synonymously with real estate. However, to the extent that certain jurisdictions refer to real estate as the land and fixtures together, as distinguished from ownership of land and appurtenances, including anything of a permanent nature such as structures, trees, minerals, and the interest, benefits, and inherent rights thereof, the term real property refers to the broadest, most inclusive description.

By way of example and not by way of limitation, real property may include land along with improvements to the land, such as buildings, fences, wells and other site improvements that are fixed in location. Similarly, real property may include hereditary allowances, rights to way, or any benefit which arises out of land, and things attached to the earth or permanently fastened to anything which is attached to the earth. For ease of discussion and not by way of limitation, the illustrations of real property discussed herein focus on the land, buildings, and fixtures disposed in the buildings.

In regard to real property and the transfer of real property, the illustrations described herein refer to rights, which may include those interests referred to as estates in certain jurisdictions. As such, real property rights may include estates in real property, such as the fee simple and leasehold. These rights may be held by a single party, or jointly with other parties. To this extent, the right holder may have a share of the rights to a particular piece of real property, which may be divisible or indivisible. These examples of real property rights are provided to illustrate the breadth of the term as used herein, but not to limit the term only these exemplary illustrations.

1. A computer implemented method for use with a computerized database comprising a plurality of unclaimed entries, each unclaimed entry comprising at least a geographic location field containing information regarding a geographic location and one or more additional editable fields, the method comprising:
transmitting, by one or more processors, information relating to an unclaimed entry to a first remote computer;
receiving, by the one or more processors, from the first remote computer a selection of the unclaimed entry to claim the unclaimed entry;
confirming, by the one or more processors, that the selection from the first remote computer originated with a right holder associated with the geographic location;
providing, by the one or more processors, the right holder an ability to modify the one or more additional editable fields associated with the claimed entry after confirming, by the one or more processors, that the selection of the entry from the first remote computer originated with the right holder associated with the geographic location;
(a) transmitting, by the one or more processors, information relating to the unclaimed entry to a second remote computer before the receipt of the selection of the unclaimed entry from the first remote computer, or (b) transmitting, by one or more processors, information relating to the claimed entry to the second remote computer after the receipt of the selection of the unclaimed entry from the first remote computer;
receiving, by the one or more processors, from the second remote computer a selection of the unclaimed or claimed entry;
receiving, by the one or more processors, communication channel information from the second remote computer to permit a communication channel to be established with an interested party at the second remote computer whether the entry is unclaimed or claimed; and
providing, by the one or more processors, the communication channel information to the right holder.

2. The computer implemented method according to claim 1, wherein the selection of the claimed entry is received from the second remote computer after the selection of the unclaimed entry is received from the first remote computer and the selection from the first remote computer is confirmed to originate with the right holder of associated with the geographic location.

3. The computer implemented method according to claim 1, wherein the selection of the unclaimed entry is received from the second remote computer before the unclaimed selection of the entry is received from the first remote computer and the selection from the first remote computer is confirmed to originate with the right holder of associated with the geographic location.

4. The computer implemented method according to claim 1, wherein the unclaimed entry and the claimed entry comprises a communication channel field, and further comprising:
storing, by the one or more processors, the communication channel information from the second remote computer in the communication channel field.

5. The computer implemented method according to claim 4, wherein providing the communication channel information to the right holder comprises:
retrieving, by the one or more processors, the communication channel information; and
displaying, by the one or more processors, the communication channel information to the right holder.

6. The computer implemented method according to claim 5, further comprising alerting, by the one or more processors, the right holder that the communication channel information has been stored prior to retrieving and displaying the communication channel information.

7. The computer implemented method according to claim 5, further comprising receiving, by the one or more processors, a selection of the communication channel information from the right holder prior to retrieving and displaying the communication channel information.

8-16. (canceled)

17. A computerized system comprising:
a real property database comprising a plurality of unclaimed entries, each unclaimed entry representing a geographic location and comprising at least a geographic location field containing information regarding the geographic location and one or more additional editable fields; and
a computerized communication and editing system in communication with the database and at least first and second remote computers, the communication and editing system comprising one or more processors and programmed to:
transmit information relating to an unclaimed entry to the first remote computer;
receive from the first remote computer a selection of the unclaimed entry to claim the unclaimed entry;
confirm that the selection from the first remote computer originated with a right holder associated with the geographic location;
provide the right holder an ability to modify the one or more additional editable fields associated with the claimed entry through the computerized communication and editing system after confirming that the selection of the entry from the first remote computer originated with the right holder associated with the geographic location;
(a) transmit information relating to the unclaimed entry to a second remote computer before receiving the selection of the unclaimed entry from the first remote computer, or (b) transmit information relating to the claimed entry to the second remote computer after receiving the selection of the unclaimed entry from the first remote computer;
receive from the second remote computer a selection of the unclaimed or claimed entry;
receive communication channel information from the second remote computer to permit a communication channel to be established with an interested party whether the entry is unclaimed or claimed; and
provide the communication channel information to the right holder.

18. The system according to claim 17, wherein the selection of the claimed entry is received from the second remote computer after the selection of the unclaimed entry is received from the first remote computer and the selection from the first remote computer is confirmed to originate with the right holder of associated with the geographic location.

19. The system according to claim 17, wherein the selection of the unclaimed entry is received from the second remote computer before the selection of the unclaimed entry is received from the first remote computer and the selection from the first remote computer is confirmed to originate with the right holder of associated with the geographic location.

20. The system according to claim 17, wherein the unclaimed entry and the claimed entry comprises a communication channel field, and the communication and editing system is programmed to:
store the communication channel information from the second remote computer in the communication channel field.

21. The system according to claim 20, wherein the communication and editing system is programmed to:
retrieve the communication channel information; and
display the communication channel information to the right holder.

22. The system according to claim 21, wherein the communication and editing system is programmed to:
alert the right holder that the communication channel information has been stored prior to retrieving and displaying the communication channel information.

23. The system according to claim 21, wherein the communication and editing system is programmed to:
receive a selection of the communication channel information from the right holder prior to retrieving and displaying the communication channel information.

24-50. (canceled)

51. A tangible non-transitory computer-readable storage medium having computer executable instructions stored thereon that, when executed by one or more processors in communication with a real property database comprising a plurality of unclaimed entries, each unclaimed entry representing a geographic location and comprising at least a geographic location field containing information regarding the geographic location and one or more additional editable fields and at least first and second remote computers, cause the one or more processors to:
transmit information relating to an unclaimed entry to the first remote computer;
receive from the first remote computer a selection of the unclaimed entry to claim the unclaimed entry;
confirm that the selection from the first remote computer originated with a right holder associated with the geographic location;
provide the right holder an ability to modify the one or more additional editable fields associated with the claimed entry through the computerized communication and editing system after confirming that the selection of the entry from the first remote computer originated with the right holder associated with the geographic location;
(a) transmit information relating to the unclaimed entry to a second remote computer before receiving the selection of the unclaimed entry from the first remote computer, or (b) transmit information relating to the claimed entry to the second remote computer after receiving the selection of the unclaimed entry from the first remote computer;
receive from the second remote computer a selection of the unclaimed or claimed entry;
receive communication channel information from the second remote computer to permit a communication channel to be established with an interested party whether the entry is unclaimed or claimed; and
provide the communication channel information to the right holder.

52. The tangible non-transitory computer-readable storage medium according to claim 51, wherein the selection of the claimed entry is received from the second remote computer after the selection of the unclaimed entry is received from the first remote computer and the selection from the first remote computer is confirmed to originate with the right holder of associated with the geographic location.

53. The tangible non-transitory computer-readable storage medium according to claim 51, wherein the selection of the unclaimed entry is received from the second remote computer before the selection of the unclaimed entry is received from the first remote computer and the selection from the first remote computer is confirmed to originate with the right holder of associated with the geographic location.

54. The tangible non-transitory computer-readable storage medium according to claim 51, wherein the unclaimed entry and the claimed entry comprises a communication channel field, and the computer executable instructions cause the one or more processors to:
store the communication channel information from the second remote computer in the communication channel field;
retrieve the communication channel information; and
display the communication channel information to the right holder.

55. The tangible non-transitory computer-readable storage medium according to claim 54, wherein the computer executable instructions cause the one or more processors to:
alert the right holder that the communication channel information has been stored prior to retrieving and displaying the communication channel information.

56. The tangible non-transitory computer-readable storage medium according to claim 54, wherein the computer executable instructions cause the one or more processors to:
receive a selection of the communication channel information from the right holder prior to retrieving and displaying the communication channel information
